(19) United States
(12) Patent Application Publication
(10) Pub. No.: US 2026/0080030 A1
(43) Pub. Date: Mar. 19, 2026

(54) Information Processing Apparatus and Information Processing Method

(71) Applicants: Hitachi, Ltd., Tokyo (JP); Rakuten Group, Inc., Tokyo (JP)

(72) Inventors: Kento HASEGAWA, Tokyo (JP); Pablo LOYOLA, Tokyo (JP); Kazuo ONO, Tokyo (JP); Andres HOYOS IDROBO, Tokyo (JP); Toyotaro SUZUMURA, Tokyo (JP); Yu HIRATE, Tokyo (JP); Masanao YAMAOKA, Tokyo (JP)

(21) Appl. No.: 19/315,993

(22) Filed: Sep. 2, 2025

(30) Foreign Application Priority Data
Sep. 18, 2024 (JP) 2024-160742

(51) Int. Cl. G06F 17/11; G06N 3/042; G06N 3/0895

(52) U.S. Cl. CPC G06F 17/11; G06N 3/042; G06N 3/0895

(57) ABSTRACT

An information processing apparatus 100 for processing a combinatorial optimization problem includes: a graph creation unit 112 configured to create one or more subgraphs from a main graph; a mathematical optimization unit 115 configured to solve a combinatorial optimization problem for each of the subgraphs by a mathematical optimization solver; a machine learning unit 117 configured to train a sub-GNN corresponding to each of the subgraphs such that an output of the sub-GNN is approximate to a solution of the mathematical optimization solver; a feature vector assignment unit 118 configured to assign a feature vector at each vertex of the sub-GNN obtained as a result of the training to each corresponding vertex of a main GNN corresponding to graph data of the main graph as an input of a feature vector of the main GNN; and a solution output unit 119 configured to output a solution obtained as a result of the machine learning unit 117 training the main GNN by setting a loss function to solve the combinatorial optimization problem for the main graph.

### CLAIM OF PRIORITY

The present application claims priority from Japanese Patent Application JP 2024-160742 filed on Sep. 18, 2024, the content of which are hereby incorporated by references into this application.

### BACKGROUND OF THE INVENTION

### 1. Field of the Invention

The present invention relates to an information processing technique for solving an optimization problem.

### 2. Description of Related Art

Combinatorial optimization problems exist in various fields of the real world such as shift scheduling optimization and delivery plan optimization. There are a wide variety of methods for solving the combinatorial optimization problem, such as linear programming, constraint programming, simulated annealing, genetic algorithms, and greedy algorithms, but the scale of a problem that can be solved within a realistic calculation time is limited in a mathematical optimization solver in which these algorithms are implemented. Even in an Ising machine that is hardware specialized for solving combinatorial optimization, the number of variables that can be implemented on the machine, that is, the scale of the problem is limited. This also applies to quantum computers that are desired to be implemented in the future, and since the number of quantum bits is limited, the scale of the combinatorial optimization problem that can be handled is also limited.

However, the scale of the combinatorial optimization problem in the real world is often huge, and it may be difficult to handle the problem as it is with the solving methods and hardware described above. Therefore, when handling a large-scale combinatorial optimization problem, the problem may be scaled down and solved, and in such cases, it is desirable to avoid a decrease in solution accuracy and an increase in solving time as much as possible.

Regarding the processing of the combinatorial optimization problem described above, PTL 1 describes that “An object of an aspect of the present invention is to provide an information processing system, an information processing method, and a program that improve solution finding performance.” and “In one aspect, an information processing system searching for a solution to a problem represented by an energy function including a plurality of state variables is provided. The information processing system includes a plurality of nodes to which a plurality of subproblems generated by dividing a problem are assigned. Each of the plurality of nodes searches for a partial solution represented by the state variable group corresponding to the subproblem assigned to the node among the plurality of state variables, and holds a plurality of solutions including a first solution to the problem, the first solution reflecting the partial solution. A first node among the plurality of nodes transmits at least one solution of the plurality of solutions held by the first node to a second node among the plurality of nodes. The second node updates at least part of the plurality of solutions held in the second node based on the solution received from the first node.”.

### CITATION LIST

### Patent Literature

PTL 1: JP2022-6994A

### SUMMARY OF THE INVENTION

PTL 1 proposes a method of dividing a large-scale combinatorial optimization problem, searching for a solution of each subproblem, combining partial solutions while transmitting and receiving the partial solutions many times between the subproblems until an end condition is satisfied to construct a complete solution, and repeating the solving processing such that an objective function value in an original problem is minimized. However, in this method, there is a problem that the number of repetition times increases until a good complete solution is acquired, and the calculation time increases. Further, simply combining partial solutions does not necessarily provide a good complete solution.

The invention has been made in view of such a background, and an object thereof is to enable improvement of solution accuracy and solving speed in a combinatorial optimization problem, particularly a large-scale combinatorial optimization problem.

In order to solve the above problem, in the invention, one or more subgraphs are created from a main graph indicating a combinatorial optimization problem, and a solution is obtained by using a result of learning, which is performed to be approximate to a solution of a mathematical optimization solver, so as to utilize high accuracy of the mathematical optimization solver. In the creation of the subgraph, it is desirable to downscale (downsize) the main graph.

More specifically, an information processing apparatus for processing a combinatorial optimization problem that allows to be defined on a graph includes: a problem data acquisition unit configured to receive problem data; a graph creation unit configured to create one or more subgraphs by downscaling a main graph that is the graph to be solved, by referring to the problem data; a mathematical optimization unit configured to solve a combinatorial optimization problem for each of the subgraphs by a mathematical optimization solver; a machine learning unit configured to train a sub-GNN corresponding to each of the subgraphs such that an output of the sub-GNN is approximate to a solution of the mathematical optimization solver, using the solution obtained by the mathematical optimization solver as labeled training data; a feature vector assignment unit configured to assign a feature vector at each vertex of the sub-GNN obtained as a result of the training to each corresponding vertex of a main GNN corresponding to graph data of the main graph as an input of a feature vector of the main GNN; and a solution output unit configured to output a solution obtained as a result of the machine learning unit training the main GNN by setting a loss function to solve the combinatorial optimization problem for the main graph.

The invention also includes an information processing method to be executed by the information processing apparatus, a program for causing the information processing apparatus to function, and a storage medium for storing the program.

According to the invention, combinatorial optimization problems can be solved quickly and with high accuracy. Problems, configurations, and effects other than those described above will become apparent in the following description of an embodiment of the invention.

### BRIEF DESCRIPTION OF THE DRAWINGS

FIG. 1 is a block diagram illustrating an example of a schematic hardware structure of an information processing apparatus 100 according to an embodiment of the invention.

FIG. 2 is a functional block diagram illustrating an example of a main functional configuration of the information processing apparatus 100 according to the embodiment of the invention.

FIG. 3 is a flowchart illustrating an example of a procedure of optimization processing in the embodiment of the invention.

FIG. 4 is a diagram illustrating an example of a solution of a maximum independent set problem in the embodiment of the invention.

FIG. 5 is a diagram illustrating an example of a process of creating a subgraph by graph compression in the embodiment of the invention.

FIG. 6 is a diagram illustrating an example of a process of creating a subgraph by graph division in the embodiment of the invention.

FIG. 7 is a flowchart illustrating an example of a procedure for solving a combinatorial optimization problem on a subgraph by a mathematical optimization solver in the embodiment of the invention.

FIG. 8 is a flowchart illustrating an example of a procedure for selecting the mathematical optimization solver to be used (details of processing step S33) in the embodiment of the invention.

FIG. 9 is a diagram illustrating an example of a graph neural network (GNN) in the embodiment of the invention.

FIG. 10 is a flowchart illustrating an example of a learning procedure of a sub-GNN (details of processing step S204) in the embodiment of the invention.

FIG. 11 is a flowchart illustrating an example of a procedure for creating a loss function of the sub-GNN (details of processing steps S42 and S43) in the embodiment of the invention.

FIG. 12 is a diagram illustrating a comparative example of learning processes of the sub-GNN with different loss functions in the embodiment of the invention.

FIG. 13 is a diagram illustrating an example of a procedure for assigning a feature vector of the subgraph to a main graph in the embodiment of the invention.

FIG. 14 is a diagram illustrating an example of a case in which all loss functions of a main GNN are described in quadratic form in the embodiment of the invention.

FIG. 15 is a diagram illustrating an example of a case in which the loss functions of the main GNN are described separately in quadratic and linear forms in the embodiment of the invention.

FIG. 16 is a diagram illustrating a comparative example of learning processes of the main GNN with different loss functions in the embodiment of the invention.

FIG. 17 is a diagram illustrating an example of a procedure for rounding an output of a continuous value obtained as a result of learning the main graph into a binary value in the embodiment of the invention.

FIG. 18 is a diagram illustrating an example of influence on a solving performance due to omitting a part of the optimization processing in the embodiment of the invention.

FIG. 19 is a diagram illustrating an example of a relation between the number of subgraphs used for learning and a solution accuracy of the main GNN in the embodiment of the invention.

### DESCRIPTION OF EMBODIMENTS

Hereinafter, an embodiment of the invention will be described in detail with reference to the drawings. In the following description, the same or similar components are denoted by the same reference numerals, and a redundant description thereof may be omitted. When there are a plurality of components having the same or similar functions, the same reference numerals may be assigned with different subscripts. In addition, when it is not necessary to distinguish the plurality of elements from each other, the subscripts may be omitted.

Although optimization problem solving processing according to the invention can be applied to many situations, a maximum independent set problem is handled in the present embodiment. The maximum independent set problem is a problem of finding a largest independent set for a given graph, and a solution accuracy can be evaluated by a size of the independent set. Here, an independent set in a certain graph is a vertex set in which no edges exist between any vertexes in the set.

In the present embodiment, graph data in a combinatorial optimization problem is downscaled to one or more subgraphs smaller in scale, and a subgraph neural network (GNN) corresponding to each subgraph is trained such that a solution of a mathematical optimization solver is approximate, and a main GNN is trained based on a result of mapping feature vectors at each node of the trained sub-GNN to nodes of the main GNN corresponding to the graph data. For this purpose, a solution obtained by the mathematical optimization solver is used as labeled training data. Details thereof will be described below. The fact that the solution of the mathematical optimization solver is approximate means that the difference satisfies a predetermined condition. The predetermined condition includes being within a predetermined rank such a minimum rank, and being within a predetermined value. The difference includes a simple difference, a square error, and the like.

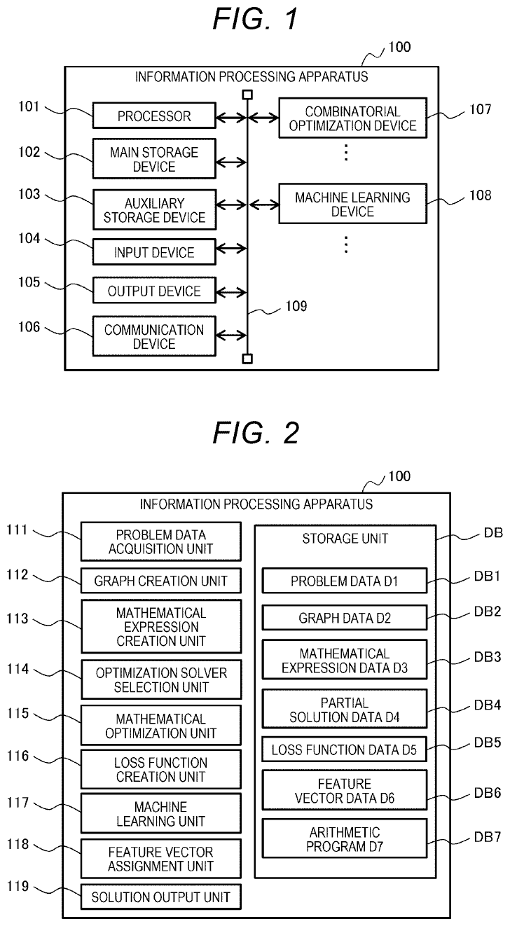

FIG. 1 is a block diagram illustrating an example of a schematic hardware structure of an information processing apparatus 100 according to the present embodiment. The information processing apparatus 100 illustrated in FIG. 1 executes work plan optimization processing as the combinatorial optimization problem. Therefore, the information processing apparatus 100 includes a processor 101, a main storage device 102, an auxiliary storage device 103, an input device 104, an output device 105, a communication device 106, one or more combinatorial optimization devices 107, one or more machine learning devices 108, and a system bus 109 that communicably connects these devices.

The information processing apparatus 100 may be partially or entirely implemented by, for example, using a virtual information processing resource such as a cloud server provided by a cloud system. The information processing apparatus 100 may be implemented by, for example, a plurality of information processing apparatuses that operate in cooperation with one another and are communicably connected to one another. In this case, the input device 104 and the output device 105 are implemented in a terminal device such as a PC connected to the information processing apparatus 100. In this case, the information processing apparatus 100 and the terminal device may be connected via a network such as the Internet. The information processing apparatus 100 may be connected to a plurality of terminal devices. Hereinafter, each component of the information processing apparatus 100 will be described.

First, the processor 101 is implemented using, for example, a central processing unit (CPU) or a micro processing unit (MPU). Therefore, the processor 101 executes various types of processing according to a program described later. The main storage device 102 is a device that temporarily stores programs and data for the processing in the processor 101. Therefore, the main storage device 102 may be implemented by, for example, a read only memory (ROM) (a static random access memory (SRAM), a non volatile RAM (NVRAM), a mask read only memory (mask ROM), a programmable ROM (PROM), or the like), or a random access memory (RAM) (a dynamic random access memory (DRAM), or the like). Therefore, the program is stored in the above-described storage device or storage medium.

The auxiliary storage device 103 is a device that stores programs and data. Therefore, the auxiliary storage device 103 may be implemented by a hard disk drive, a flash memory, a solid state drive (SSD), an optical storage device (a compact disc (CD), a digital versatile disc (DVD), or the like), or the like. The programs and data stored in the auxiliary storage device 103 are read into the main storage device 102 as needed for the processing in the processor 101.

The input device 104 is a user interface that receives input of information from a user. The input device 104 may be implemented by, for example, a keyboard, a mouse, a card reader, or a touch panel. The output device 105 is a user interface that provides information to the user. The output device 105 may be implemented by, for example, a display device (a liquid crystal display (LCD), a graphics card, or the like) that visualizes various information, an audio output device (speaker), or a printing device. The input device 104 and the output device 105 may be implemented in another terminal device as described above. Further, the input device 104 and the output device 105 may be integrally implemented like a touch panel.

The communication device 106 is a communication interface that communicates with other devices such as the terminal device. Therefore, the communication device 106 may be implemented by, for example, a network interface card (NIC), a wireless communication module, a universal serial interface (USB) module, or a serial communication module.

The combinatorial optimization device 107 is a device that solves an input combinatorial optimization problem. The combinatorial optimization device 107 may be, for example, dedicated hardware designed specifically to execute a metaheuristic algorithm such as simulated annealing, or may be dedicated hardware for searching a solution to an optimization problem expressed as an Ising model. However, instead of providing the dedicated combinatorial optimization device 107, the processor 101 for general-purpose calculation may function as the combinatorial optimization device 107 to solve the combinatorial optimization problem.

In addition, the combinatorial optimization device 107 may be implemented, for example, in the form of an expansion card attached to the information processing apparatus 100, such as a graphics processing unit (GPU). Further, the combinatorial optimization device 107 may be implemented by, for example, hardware such as a complementary metal oxide semiconductor (CMOS) circuit, a field programmable gate array (FPGA), or an application specific integrated circuit (ASIC).

The machine learning device 108 is a device that executes arithmetic processing of machine learning on an input neural network. Therefore, the machine learning device 108 may be responsible for at least one of a process of training the neural network and a process of executing inference using the trained neural network and presenting a result.

Therefore, the machine learning device 108 may take, for example, the form of an expansion card attached to the information processing apparatus 100, such as a graphics processing unit (GPU). Further, the machine learning device 108 may be implemented by, for example, an AI chip specially designed by hardware such as a complementary metal oxide semiconductor (CMOS) circuit, a field programmable gate array (FPGA), or an application specific integrated circuit (ASIC). However, instead of providing the dedicated machine learning device 108, the processor 101 may function as the machine learning device 108 to execute machine learning.

The combinatorial optimization device 107 and the machine learning device 108 include a control device, a storage device, an interface for connecting to the system bus 109, and the like, and transmit and receive commands and information to and from the processor 101 via the system bus 109. For example, the combinatorial optimization device 107 and the machine learning device 108 may be communicably connected to another combinatorial optimization device 107 via a communication line and operate in cooperation with the another combinatorial optimization device 107.

Next, functions of the information processing apparatus 100 will be described. FIG. 2 is a functional block diagram illustrating a main functional configuration (software configuration) of the information processing apparatus 100 according to the present embodiment. The information processing apparatus 100 illustrated in FIG. 2 includes a problem data acquisition unit 111, a graph creation unit 112, a mathematical expression creation unit 113, an optimization solver selection unit 114, a mathematical optimization unit 115, a loss function creation unit 116, a machine learning unit 117, a feature vector assignment unit 118, a solution output unit 119, and a storage unit DB.

Functions of the problem data acquisition unit 111 to the feature vector assignment unit 118 are achieved by the processor 101 reading out and executing a program stored in the main storage device 102 or by the combinatorial optimization device 107 or the machine learning device 108. A function of the solution output unit 119 may be achieved by the output device 105 and/or the communication device 106. In addition to the functions described above, the information processing apparatus 100 may have other functions such as an operating system, a file system, a device driver, and a database management system (DBMS).

The storage unit DB includes a problem data storage unit DB1, a graph data storage unit DB2, a mathematical expression data storage unit DB3, a partial solution data storage unit DB4, a loss function data storage unit DB5, a feature vector data storage unit DB6, and an arithmetic program storage unit DB7. Therefore, the storage unit DB may be implemented by the main storage device 102 or the auxiliary storage device 103.

The problem data acquisition unit 111 acquires external information that is information input from the outside in order to set a problem to be solved or various conditions at the time of solving. The problem data acquisition unit 111 desirably stores the external information in the problem data storage unit DB1 of the storage unit DB as problem data D1. The external information (problem data D1) includes information such as a setting condition of a combinatorial optimization problem to be solved, a weighting setting in an optimization index, an upper limit of a calculation time, a target graph, the number of layers and the type of an activation function in a graph neural network (GNN), a dimension of a feature vector to be assigned to each vertex, and a learning termination condition. The external information is received by the user via a user interface (the input device, the output device, the communication device, or the like).

The graph creation unit 112 creates a graph from the problem data D1 stored in the problem data storage unit DB1. The graph creation unit 112 creates an original graph (main graph) to be actually solved from the problem data D1, and creates one or more subgraphs that are downscaled (downsized) from the main graph, that is, smaller in scale. The downscaling includes compression and/or division of the main graph. Here, the graph creation unit 112 stores the created main graph and subgraph as graph data D2 in the graph data storage unit DB2. The graph may be stored in the form of an adjacency matrix, a distance matrix, an adjacency list, or the like.

The mathematical expression creation unit 113 creates (formulates) mathematical expression data of the combinatorial optimization problem from the problem data D1 and the graph data D2. Then, the mathematical expression creation unit 113 desirably stores the created mathematical expression data as mathematical expression data D3 in the mathematical expression data storage unit DB3 of the storage unit DB. Here, when a quadratic expression is included in an objective function of the combinatorial optimization problem, the mathematical expression creation unit 113 desirably converts a term of the quadratic expression represented by a square of the same binary variable into a linear term while maintaining a coefficient of the quadratic term, and creates (converts) a mathematical expression of the objective function by a quadratic expression including only a cross term that is a product between different variables and a linear expression including the converted linear term. This will be described in detail later using formulas.

The optimization solver selection unit 114 selects an optimization solver to be used for solving the combinatorial optimization problem in the mathematical optimization unit 115 based on the problem data D1, the graph data D2 stored in the graph data storage unit DB2, and the mathematical expression data D3 stored in the mathematical expression data storage unit DB3.

The mathematical optimization unit 115 uses the optimization solver selected by the optimization solver selection unit 114 to find a solution to the mathematical expression data D3 of the combinatorial optimization problem. Then, the mathematical optimization unit 115 desirably stores the found solution in the partial solution data storage unit DB4 as partial solution data D4.

The loss function creation unit 116 creates a loss function for machine learning from the problem data D1, the graph data D2, the mathematical expression data D3, and the partial solution data D4. The loss function creation unit 116 desirably stores the created loss function in the loss function data storage unit DB5 as loss function data D5.

The machine learning unit 117 creates a GNN from the problem data D1 and the graph data D2. Then, the machine learning unit 117 executes learning of the GNN using the problem data D1 and the loss function data D5. As a result, the machine learning unit 117 trains the sub-GNN corresponding to the subgraph of the graph data D2 by using the partial solution data D4, which is a solution result in the mathematical optimization unit 115, as labeled training data such that the output of the sub-GNN is approximate to the solution of the mathematical optimization solver.

The machine learning unit 117 desirably stores the feature vector of the GNN obtained as a result of the learning in the feature vector data storage unit DB6 as feature vector data D6. Further, the machine learning unit 117 may output a variable value (solution of the combinatorial optimization problem) obtained as a result of learning to the solution output unit 119.

In addition, the feature vector assignment unit 118 determines, from the graph data D2 and the feature vector data D6, from which vertex of the main graph each vertex of the subgraph is created. It is desirable that the feature vector assignment unit 118 sets, as an initial input value of the feature vector of each vertex of the main GNN, a linear combination of the feature vectors obtained by the learning of the sub-GNN for a vertex group of the subgraph corresponding to each vertex of the main GNN.

The solution output unit 119 reads out the solution obtained by the machine learning unit 117, calculates an objective function value, the number of constraint violations, and the like of the combinatorial optimization problem from the problem data D1, the graph data D2, and the mathematical expression data D3, and outputs the values to the output device 105 and the communication device 106.

The arithmetic program storage unit DB7 stores an arithmetic program D7. Here, the arithmetic program D7 is a program for causing each unit to function as follows.

The graph creation unit 112 creates the main graph and the subgraph.

The mathematical expression creation unit 113 creates a formulation.

The mathematical optimization unit 115 solves the combinatorial optimization problem.

The loss function creation unit 116 creates the loss function.

The machine learning unit 117 executes machine learning using the given loss function.

The solution output unit 119 calculates the objective function value and the number of constraint violations.

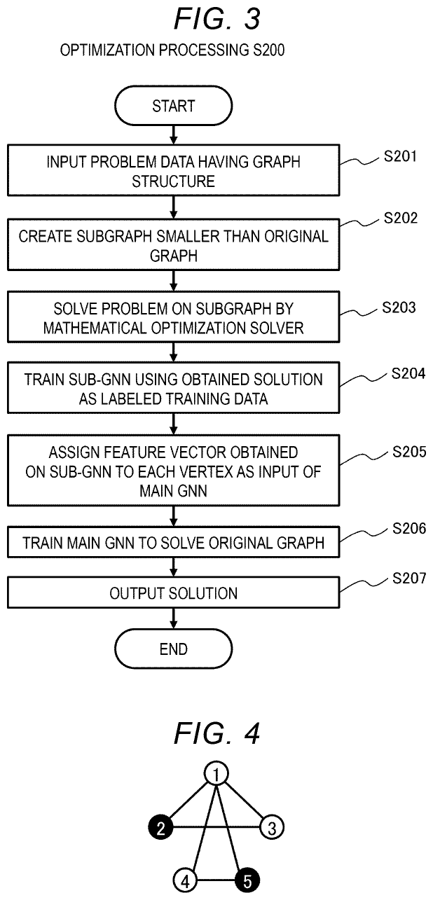

Next, a processing flow according to the present embodiment will be described. FIG. 3 is a flowchart illustrating an example of a procedure of the optimization processing in the embodiment of the invention. The optimization processing illustrated in FIG. 3 may be executed by each functional unit illustrated in FIG. 2 using the information processing apparatus 100 implemented by the hardware illustrated in FIG. 1. Hereinafter, the processing executed by the information processing apparatus 100 illustrated in FIG. 3 is referred to as optimization processing S200. In the following description, a letter “S” attached before a reference sign means a processing step. The optimization processing S200 is started by, for example, receiving an instruction or the like from the user via the input device 104.

Hereinafter, a rough flow of the optimization processing S200 will be described with reference to FIG. 3. First, in processing step S201, the problem data acquisition unit 111 receives input of data of a combinatorial optimization problem having a graph structure in accordance with an operation from the user. The combinatorial optimization problem having a graph structure is not limited to a problem originally defined on a graph, such as a maximum independent set problem, a maximum cut problem, or a traveling salesman problem, and may be any problem as long as an interaction between decision variables can be expressed by a graph.

In addition, in processing step S201, it is also possible to receive input of information from the user regarding the weighting setting in the optimization index, the upper limit of the calculation time, the number of layers and the type of the activation function in the graph neural network (GNN) to be used in processing steps S204 and S205, the dimension of the feature vector to be assigned to each vertex, the learning termination condition, and a feature vector assignment method in processing step S205. The problem data input by the user may be stored as the problem data D1 in the problem data storage unit DB1 by the problem data acquisition unit 111.

In processing step S202, the graph creation unit 112 creates a graph (main graph) to be created with reference to the problem data D1 input in processing step S201. However, when the combinatorial optimization problem input in processing step S201 is a problem originally defined on the graph and the main graph is already input to the problem data D1, it is not necessary to create the main graph. When the main graph is not input to the problem data D1, the graph creation unit 112 creates the main graph with each decision variable as a vertex in the target combinatorial optimization problem. Edges in the main graph may be set between all vertexes or may be set only between correlated decision variables.

In addition, in processing step S202, the graph creation unit 112 creates subgraphs each having a smaller number of vertexes or edges than the main graph. That is, the graph creation unit 112 creates the subgraph by downscaling the main graph. Here, the number of subgraphs may be one or more, and a plurality of subgraphs may be created. In the creation of the subgraph, a clustering method such as the Louvain method, the KMeans method, or DBSCAN may be used. In addition, a subgraph may be created by compressing a plurality of vertexes included in the same cluster into a single vertex, or each cluster may be regarded as a separate subgraph.

Here, the graph creation unit 112 desirably stores the main graph and the subgraph created in processing step S202 in the graph data storage unit DB2 as the graph data D2. The graph creation unit 112 also records, in the graph data D2, to which vertex of the subgraph each vertex of the main graph corresponds.

In addition, in processing step S203, the mathematical expression creation unit 113 formulates a combinatorial optimization problem for each subgraph created in processing step S202. Here, it is assumed that the optimization solver selection unit 114 sets an optimization solver and/or an algorithm used for solving. Then, the mathematical optimization unit 115 solves the combinatorial optimization problem on the subgraph. The mathematical optimization unit 115 desirably stores the obtained solution in the partial solution data storage unit DB4 as the partial solution data D4.

In processing step S204, the loss function creation unit 116 first refers to the partial solution data D4 and creates a loss function using the solution obtained in processing step S203 as labeled training data. Further, the machine learning unit 117 creates a sub-GNN for each subgraph based on the information designated by the problem data D1. Then, the machine learning unit 117 trains the sub-GNN using the loss function stored in the loss function data D5. The machine learning unit 117 desirably stores the feature vector of each vertex in a first layer of the GNN obtained as a result of the training in the feature vector data storage unit DB6 as the feature vector data D6.

In processing step S205, the machine learning unit 117 assigns the feature vector on the subgraph obtained in processing step S204 to each corresponding vertex of the original main graph. Here, the corresponding vertex of the main graph indicates a vertex corresponding to a generation source of each vertex of the subgraph.

In processing step S206, the loss function creation unit 116 creates a loss function for the main graph. Here, processing step S206 is intended to solve the combinatorial optimization problem, and when creating the loss function, the loss function creation unit 116 refers to the mathematical expression data D3 so that the result of learning of the main GNN becomes the solution result of the combinatorial optimization problem. Next, the machine learning unit 117 creates the main GNN for the main graph based on the information designated by the problem data D1. Then, the machine learning unit 117 trains the main GNN using the loss function stored in the loss function data D5 with the feature vector assigned in processing step S205 as an input of the feature vector of each vertex.

In processing step S207, the solution output unit 119 reads the solution obtained in processing step S206, calculates the objective function value, the number of constraint violations, and the like, and outputs the solution and the calculation results. Here, the solution output unit 119 outputs the solution and the calculation results to the output device 105 and the communication device illustrated in FIG. 1.

To simply describe the optimization processing illustrated in FIG. 3 above, three-stage arithmetic processing is performed in which the original main graph is downscaled, for example, compressed and/or divided to create small-scale subgraphs, the solution obtained by the mathematical optimization solver for the combinatorial optimization problem on each subgraph is used as labeled training data to train the sub-GNN, and the feature vector obtained as a result of the training is used as an input to the main GNN to train the main GNN.

Hereinafter, a specific example of the optimization processing S200 will be described using the maximum independent set problem as an example. As described above, the maximum independent set problem is a problem of finding an independent set having a largest size in a given graph G. For example, in a graph including five vertexes 1 to 5 as illustrated in FIG. 4, one of maximum independent sets is {vertex 2, vertex 5}, and the size thereof is 2. Hereinafter, each processing step of the optimization processing S200 will be described in detail in order in consideration of solving the maximum independent set problem on a huge graph.

First, in processing step S201, the problem data acquisition unit 111 receives designation from the user that the combinatorial optimization problem is the maximum independent set problem, and receives input of graph data to be solved. Here, the input graph data is referred to as a main graph. In addition, a setting condition of a graph neural network (GNN) to be used in a subsequent processing step, a selection condition of a mathematical optimization solver, and the like may be received, but necessary inputs will be described later together with a description of the subsequent processing steps.

In processing step S202, the graph creation unit 112 creates subgraphs smaller than the main graph by downscaling the main graph by graph compression or graph division. In the creation of the subgraph, a known clustering method such as the Louvain method, the KMeans method, or DBSCAN may be used. In addition, the downscaling may include methods other than compression and division, and also includes a combination of two or more downscaling methods such as division and compression.

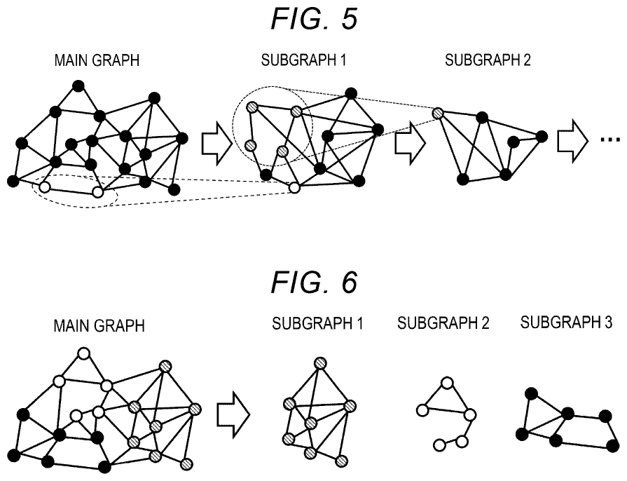

FIG. 5 illustrates an example of creating a subgraph by graph compression. In graph compression, the graph creation unit 112 creates a subgraph by regarding each cluster as a single vertex. For example, when two vertexes indicated by white in the main graph form a single cluster, these vertexes are grouped into a single vertex in a subgraph 1. Similarly, the graph creation unit 112 creates subgraphs by regarding other clusters in the main graph as single vertexes. Edges in the subgraph may be created according to the clustering method, but for example, when there is an edge between clusters in the main graph, the edge may be created between corresponding vertexes on the subgraph.

Further, the graph creation unit 112 may create a plurality of subgraphs. As illustrated in FIG. 5, the graph creation unit 112 may further perform clustering using the clustering method on a certain subgraph 1, compress the graph by regarding each cluster as a vertex, and create a subgraph 2. By repeating the same process, a plurality of subgraphs can be created while scaling down, such as a subgraph 3, and a subgraph 4.

Next, FIG. 6 illustrates an example of creating a subgraph by graph division. When the graph division is used, the graph creation unit 112 clusters the main graph and sets each cluster as a separate subgraph. In FIG. 6, vertex groups indicated by an oblique line pattern, a hollow pattern, and a filled pattern are referred to as a subgraph 1, a subgraph 2, and a subgraph 3, respectively.

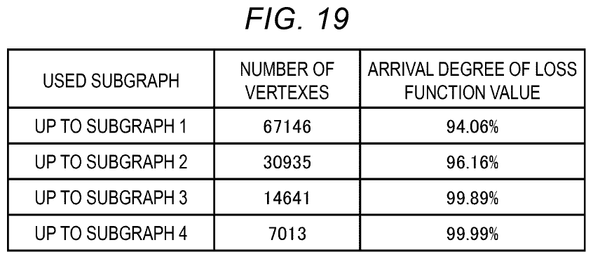

The subgraph created in processing step S202 needs to have a scale that can be sufficiently handled by the mathematical optimization solver used in subsequent processing step S203. That is, the role of processing step S202 is to reduce the scale so that a large-scale main graph can be handled by the mathematical optimization solver. Although the effect will be described later with reference to FIG. 19, in order to store the information of the main graph as much as possible, the scale of the subgraph is preferably as large as possible within a range in which the subgraph can be handled by the mathematical optimization solver.

Therefore, the graph creation unit 112 may use various parameter settings in an algorithm of the graph compression or graph division designated by the user in advance in the problem data D1. That is, the graph creation unit 112 may create a subgraph or a graph using the setting parameters in which the parameters are set. In addition, the graph creation unit 112 may repeat the algorithm of the graph compression or graph division until a subgraph having a desirable size is obtained while mechanically correcting the various parameter settings. That is, the graph creation unit 112 repeats the subgraph creation processing while changing the setting parameters.

The various parameters in the algorithm of the graph compression or graph division include, for example, a resolution parameter that affects the size of a cluster and the number of repetition times of clustering in the case of the Louvain method, and the number of clusters in the case of the KMeans method.

Hereinafter, a case in which the subgraph creation processing of creating a subgraph by the graph compression method illustrated in FIG. 5 is executed will be described as an example. In processing step S203 illustrated in FIG. 3, the mathematical expression creation unit 113 formulates the combinatorial optimization problem on the subgraph created in processing step S202, and performs solving using the mathematical optimization solver. In the case of the present embodiment, the mathematical expression creation unit 113 solves the maximum independent set problem for each subgraph.

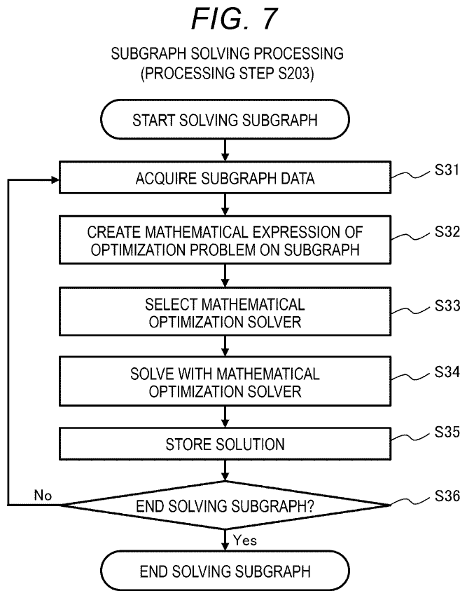

Here, FIG. 7 illustrates a detailed flowchart of processing step S203 which is subgraph solving processing. First, in processing step S31, the mathematical expression creation unit 113 reads the subgraph created in processing step S202. Next, in processing step S32, the mathematical expression creation unit 113 formulates the maximum independent set problem for the read subgraph. For example, the maximum independent set problem can be formulated as the following (Math. 1).

$$\begin{matrix}Math . 1 & \\ {minimize}_{x ∈ {\{ 0 , 1 \}}^{n}} H = - {\sum }_{i ∈ V} {x}_{i} + P {\sum }_{( i , j ) ∈ E} {x}_{i} {x}_{j} & ( Math . 1 )\end{matrix}$$

Here, n, V, and E are the number of vertexes, a vertex set, and an edge set of the subgraph, respectively, and xᵢ is a binary variable that becomes 1 when a vertex i belongs to an independent set and becomes 0 when the vertex i does not belong to the independent set. P is a penalty coefficient, and may be designated in advance by the user and stored in the problem data D1. A first term of H in (Math. 1) corresponds to the size of the independent set, and a second term is a penalty term for prohibiting both adjacent vertexes from being included in the independent set.

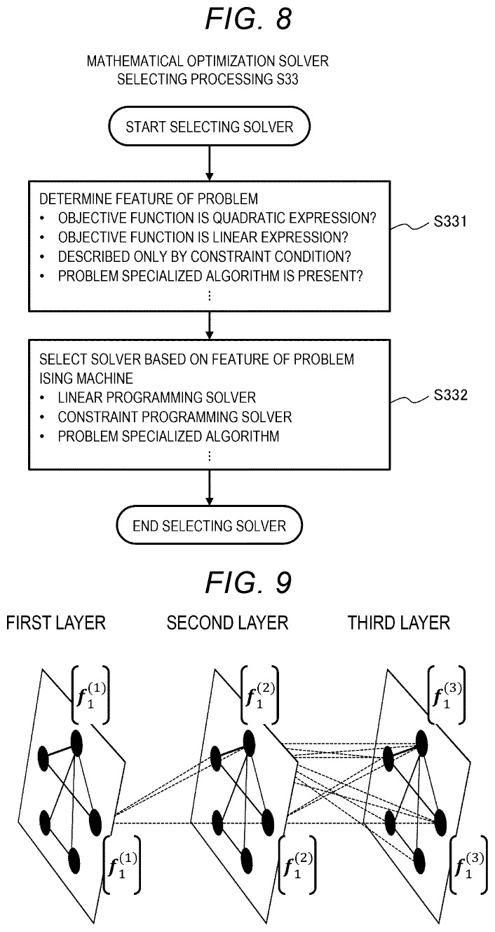

In addition, in processing step S33, the mathematical expression creation unit 113 determines a feature of the mathematical expression of the combinatorial optimization problem designated in the problem data D1 or the problem created in processing step S32, and selects a mathematical optimization solver to be used in subsequent processing step S34. Here, FIG. 8 illustrates a detailed flowchart of processing step S33 in FIG. 7. First, in processing step S331, the mathematical expression creation unit 113 determines a feature of the given combinatorial optimization problem. Here, regarding this feature, for example, it is determined whether the objective function serving as the optimization index in the mathematical expression created in processing step S32 is a quadratic expression or a linear expression. In addition, it may be determined whether the mathematical expression is described only by the constraint condition, whether there is a dedicated algorithm specialized for the combinatorial optimization problem to be solved, or the like.

Subsequently, in processing step S332, the mathematical expression creation unit 113 receives the result of the feature determination in processing step S331, and selects a mathematical optimization solver or an algorithm to be used in subsequent processing. Here, options for a general-purpose mathematical optimization solver may include, for example, an Ising machine, a linear programming solver, and a constraint programming solver. In addition, the options may also include problem specialized algorithms such as a specially designed greedy algorithm. An example of the problem specialized algorithm for the maximum independent set problem is the Boppana-Halldorsson algorithm.

In processing step S332, the mathematical expression creation unit 113 selects a mathematical optimization solver as follows according to the feature determination in processing step S331. For example, the selection is made as follows.

The Ising machine is selected if the objective function is determined to be a quadratic expression, the linear programming solver is selected if the objective function is determined to be a linear expression, the constraint programming solver is selected if only the constraint condition is present, and the problem specialized algorithm is selected if the problem specialized algorithm is present.

However, the mathematical expression creation unit 113 may use a mathematical optimization solver used in the problem data D1 designated in advance by the user. In addition, in a case in which a plurality of conditions are satisfied, such as when the objective function is a quadratic expression and the problem specialized algorithm is present, which mathematical optimization solver is to be adopted may be determined by designating a priority order of the mathematical optimization solvers. The priority order may be stored in the problem data D1 in advance by the user.

In the present embodiment, since the objective function is represented by a quadratic expression as illustrated in (Math. 1), the description will be continued assuming that the Ising machine is selected as the mathematical optimization solver.

In addition, in processing step S34 illustrated in FIG. 7, the mathematical expression creation unit 113 solves the combinatorial optimization problem (the maximum independent set problem in the case of the present embodiment) on the subgraph with the designated mathematical optimization solver. At this time, the mathematical expression created in processing step S32 may be used as an input to the mathematical optimization solver. Next, in processing step S35, the mathematical expression creation unit 113 stores a solution xᵢ (i=1, 2, . . . , N), which is obtained as a result of solving by the mathematical optimization solver, as the partial solution data D4 illustrated in FIG. 2.

In addition, in processing step S36, the mathematical expression creation unit 113 determines whether to end the solving processing by the mathematical optimization solver on the subgraph. Examples of a determination condition include whether the solving processing is executed for all the created subgraphs, and whether the processing time reaches a processing time designated by the user in advance in the problem data D1. When it is determined to end the solving (Yes), processing step S203 which is the subgraph solving processing is ended. When it is not determined to end the solving (No), the processing returns to processing step S31, data of the next subgraph is acquired, and processing steps S32 to S36 are repeated. However, in FIG. 7, the mathematical expression creation unit 113 sequentially executes the solving processing for each subgraph, but the solving processing may be executed in parallel for a plurality of subgraphs.

Returning to FIG. 3 again, the procedure of the optimization processing will be described. In processing step S204, the machine learning unit 117 creates a GNN for each subgraph, and trains the GNN using the solution obtained by solving by the mathematical optimization solver as labeled training data.

The GNN is a neural network targeting data having a graph structure, and propagates and processes information on the graph. Each vertex on the graph has numerical data on a vector called a feature vector. In the GNN, the feature vector is updated by transmitting information between adjacent vertexes. If the feature vector of the vertex i in a k-th layer of the GNN is fᵢ^{(v)}, the feature vector of a (k+1)-th layer is determined, for example, as in the following (Math. 2).

$$\begin{matrix}Math . 2 & \\ {f}_{i}^{k + 1} = {R}^{( k )} ( {W}^{( k )} \cdot \frac{{\sum }_{u ∈ N ( i )} {f}_{i}^{( k )}}{\vert N ( i ) \vert} + {B}^{( k )} \cdot {f}_{i}^{( k )} ) & ( Math . 2 )\end{matrix}$$

Here, R^{(k)} and N(i) are an activation function of the k-th layer and a vertex set adjacent to the vertex i, respectively. W^{(k)} and B^{(k)} are weights for information propagation between vertexes in the k-th layer, and are learning parameters in machine learning.

The above GNN is schematically illustrated in FIG. 9. In FIG. 9, the GNN includes three layers. The feature vectors of the respective layers are indicated by f₁⁽¹⁾ to f₃⁽¹⁾. Here, a graph convolution network (GCN) is taken as an example of the GNN, but other types of GNNs such as a graph attention network (GAT) may be used. It is desirable for the user to store settings related to the structure of the GNN, such as GCN or GAT, the dimension of the feature vector, the number of layers of the GNN, the activation function, and an initial value of a learning rate, in the problem data D1 in advance. However, the dimension of the feature vector in a final layer of the GNN is the same as the variable of the combinatorial optimization problem assigned to each vertex of the subgraph. In the case of the maximum independent set problem, since the variable xᵢ of each vertex is a binary variable indicating whether the vertex is included in the independent set and is a scalar (one-dimensional), the feature vector of the final layer of the GNN is also set to a scalar (one-dimensional).

In the learning of the GNN, a loss function is defined using the feature vector of the final layer, and the learning parameter such as W^{(k)} and B^{(k)} is optimized so as to minimize the loss function. In the present embodiment, adaptive moment estimation (Adam) is used as the optimization algorithm of the learning parameter, but other methods such as a stochastic gradient descent method or adaptive gradient algorithm (AdaGrad) may be used.

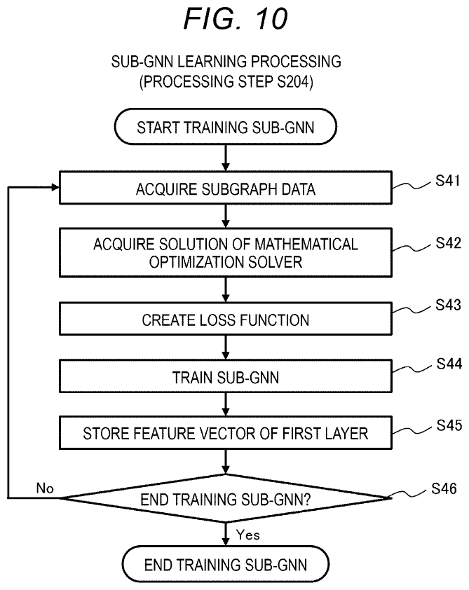

Next, details of processing step S204 illustrated in FIG. 3 will be described. FIG. 10 is a flowchart illustrating the details of processing step S204 in FIG. 3, which is sub-GNN learning processing. First, in processing step S41, the loss function creation unit 116 acquires data of a subgraph to be trained. In addition, in processing step S42, the loss function creation unit 116 acquires the solution of the mathematical optimization solver for the target subgraph from the partial solution data D4. Then, in processing step S43, the loss function creation unit 116 creates a loss function from the acquired solution of the mathematical optimization solver and the mathematical expression of the combinatorial optimization problem created in processing step S32 in FIG. 7.

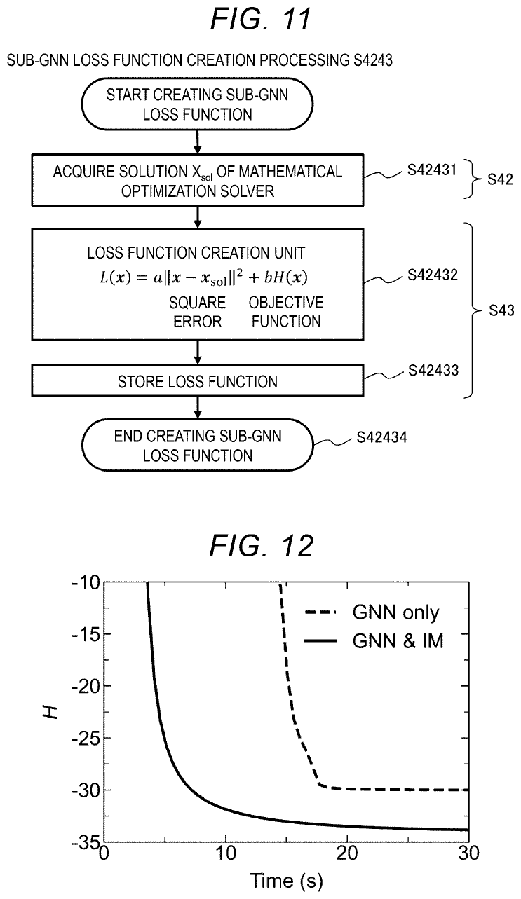

FIG. 11 illustrates a detailed flowchart of processing steps S42 and S43. For convenience, FIG. 11 (processing steps S42 and S43) is referred to as sub-GNN loss function creation processing S4243. In processing step S42431 in the sub-GNN loss function creation processing S4243, the loss function creation unit 116 acquires the solution of the mathematical optimization solver and sets the solution as xₛₒₗ. This corresponds to processing step S42 in FIG. 10. In processing step S42432, the loss function creation unit 116 creates a loss function L(x) of the GNN (sub-GNN) for the target subgraph. Here, the sum of a square error with the solution xₛₒₗ of the mathematical optimization solver and the objective function (the function H in (Math. 1)) of the combinatorial optimization problem is set as the loss function. However, weighting coefficients a and b set in the respective terms are designated by the user in advance for the problem data D1. One of the weighting coefficients may be 0.

The reason why the square error with xₛₒₗ is set in the loss function is to cause the GNN to mimic the solution of the mathematical optimization solver. In processing step S42433, the loss function creation unit 116 stores the loss function created for the sub-GNN as the loss function data D5. Processing steps S42432 and S42433 correspond to processing step S43 in FIG. 10. Thus, in processing step S42434, the creation of the loss function for the sub-GNN ends.

Here, a learning process of the sub-GNN will be described with reference to FIG. 12. FIG. 12 illustrates a result when the instance C125-9 of the DIMACS benchmark set is regarded as a subgraph and the maximum independent set problem is solved using two loss functions. In FIG. 12, the vertical axis represents the objective function H in (Math. 1), and the horizontal axis represents the calculation time.

In the GNN only case in FIG. 12, the weighting coefficient a=0, and the objective function is used as the loss function as it is. In this example, information on the solution xₛₒₗ of the mathematical optimization solver is not received at all, and the subgraph is created by the GNN alone. Meanwhile, in the GNN & IM case, the weighting coefficient b=0, and only the square error with the solution xₛₒₗ of the mathematical optimization solver is used as the loss function. In the present embodiment, the Ising machine is used as the mathematical optimization solver. In FIG. 12, the time required for solving in the Ising machine is also added and displayed.

Here, when the results of the GNN only case and the GNN & IM case are compared, it can be seen that the learning in the GNN & IM case progresses faster and more accurately. This indicates that the learning performance of the GNN can be improved by acquiring information from the solution of the Ising machine rather than solving with the GNN alone. However, when learning is executed on a graph of a scale that can be handled by the mathematical optimization solver and a huge main graph is handled, information obtained by the mathematical optimization solver is transmitted to the main GNN via the sub-GNN.

Returning to FIG. 10, the processing flow will be described. In processing step S44, the machine learning unit 117 constructs the sub-GNN with the setting designated by the user in the problem data D1, and trains the sub-GNN using the loss function created in processing step S43. The learning parameter in the sub-GNN and the initial value of the feature vector of the first layer may be randomly determined by the machine learning unit 117 even if the machine learning unit 117 receives designation in the problem data D1 from the user. An end condition of the learning may be designated by the user for the loss function. Examples of the end condition include setting an upper limit of the calculation time or the number of epochs, and until the improvement in the loss function value equal to or greater than the designated value is not observed between the designated number of epochs.

Further, in processing step S45, the machine learning unit 117 stores the feature vector of the first layer of the sub-GNN obtained as a result of the learning as the feature vector data D6. In addition, in processing step S46, the machine learning unit 117 determines whether to end processing step S204 which is the sub-GNN learning processing. This determination condition is similar to that of processing step S36 in FIG. 7, and examples thereof include whether learning is executed for all subgraphs, and whether the processing time reaches the processing time designated by the user. When the learning of the sub-GNN is to be continued (No), the processing returns to processing step S41, data of another subgraph is acquired, and processing steps S42 to S46 are repeated. However, in FIG. 10, the sub-GNN learning processing is sequentially executed for each subgraph, but the sub-GNN learning processing may be executed in parallel for a plurality of subgraphs.

Referring back to FIG. 3, the description will be continued. In processing step S205, the feature vector assignment unit 118 assigns the feature vector obtained by the learning of each sub-GNN to each vertex of the main GNN in order to use the feature vector as an initial value (feature vector of the first layer) of the feature vector of the GNN (main GNN) for the main graph.

This assignment will be described with reference to FIG. 13. FIG. 13 is a diagram illustrating a feature vector assignment method in processing step S205 in FIG. 3. Hereinafter, it is assumed that the vertex indicated by a hollow pattern in the main graph is a vertex 1, and a feature vector of a first layer of the vertex 1 is f₁, main⁽¹⁾. Hereinafter, a method of determining f_{1, main}⁽¹⁾ will be described.

First, in the graph compression in processing step S202 in FIG. 3, it is assumed that a cluster including the vertex 1 of the main graph is compressed to a hollow point of the subgraph 1. The hollow point in the subgraph 1 is a vertex 1′ of the subgraph 1. In this case, the vertex 1 of the main graph can be said to correspond to the vertex 1′ in the subgraph 1. Further, when a cluster including the vertex 1′ of the subgraph 1 is compressed to a hollow vertex 1″ of a subgraph 2, the vertex 1 of the main graph can be said to correspond to the vertex 1″ in the subgraph 2. The graph creation unit 112 can obtain a vertex corresponding to the vertex 1 of the main graph for each subgraph in the same manner.

In addition, as illustrated in a lower part of FIG. 13, for the vertex of each subgraph corresponding to the vertex 1 of the main graph, an average value of their feature vectors may be f_{1, main}⁽¹⁾. N in the drawing represents the number of subgraphs. Here, the feature vector of the vertex of the subgraph indicates the feature vector acquired by the learning in processing step S204 in FIG. 3, and can be read out from the feature vector data D6 in FIG. 2. In the present embodiment, the average value of the feature vectors of all the subgraphs is simply used, whereas the feature vector of each subgraph may be weighted. This weighting may be designated by the user in advance or may be determined according to the number of nodes of the subgraph.

Although the method of determining the initial value of the feature vector is described above using the vertex 1 of the main graph as an example, the same processing is executed for all vertexes of the main graph. As described above, in the present embodiment, the feature vector assignment unit 118 determines from which vertex of the main graph each vertex of the subgraph is created, and sets, as the initial input value of the feature vector of each vertex of the main GNN, a linear combination of the feature vectors obtained by the training of the sub-GNN for a vertex group of the subgraph corresponding to each vertex of the main GNN. Through this processing, information obtained by the training of the sub-GNN can be taken over to the main GNN. Further, since the sub-GNN obtains information from the mathematical optimization solver, the main GNN can consequently receive the information from the mathematical optimization solver.

Returning to FIG. 3 again, the processing flow will be described. In processing step S206, the machine learning unit 117 solves the combinatorial optimization problem originally desired to be solved, that is, the combinatorial optimization problem on the original main graph by learning of the main GNN. Similarly to the sub-GNN, the user may designate configuration conditions of the GNN in the problem data D1 in advance. However, in solving the maximum independent set problem, the feature vector of the final layer is also one-dimensional (scalar).

In the present embodiment, the mathematical expression of the combinatorial optimization problem is used as a loss function used in the learning of the main GNN. In the case of the maximum independent set problem, the mathematical expression (Math. 1) created in processing step S32 in FIG. 7 may be used. The constraint condition may be included in the objective function H (=loss function L) as a penalty term as in the second term of (Math. 1).

When creating the loss function, if the variable xᵢ is a binary variable of 0/1, all linear expressions of xᵢ can be converted into quadratic expressions using the relation illustrated in (Math. 3).

$$\begin{matrix}Math . 3 & \\ {x}_{i} = {x}_{i}^{2} & ( Math . 3 )\end{matrix}$$

Therefore, the loss function L can be expressed only by a quadratic expression as in (Math. 4).

$$\begin{matrix}Math . 4 & \\ L = {\sum }_{i , j ( \geq i )} {q}_{i , j} {x}_{i} {x}_{j} ( = {x}^{T} Qx ) & ( Math . 4 )\end{matrix}$$

When the objective function of the maximum independent set (Math. 1) is transformed, (Math. 5) is obtained.

$$\begin{matrix}Math . 5 & \\ {q}_{i , j} = \{ \begin{matrix}- 1 & ( i = j ) \\ P & ( i < j ∧ ( i , j ) ∈ E ) \\ 0 & ( i > j )\end{matrix} & ( Math . 5 )\end{matrix}$$

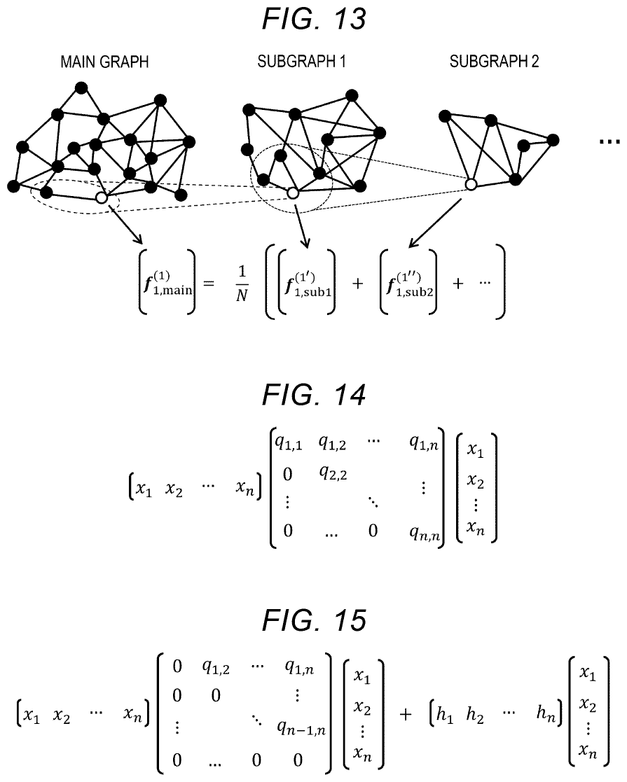

FIG. 14 illustrates the expression x^{T}Qx of (Math. 4) in a matrix form, where the diagonal term of the interaction matrix Q has a finite value. When such a loss function in the x^{T}Qx form is differentiated with respect to a certain learning parameter p, (Math. 6) is obtained.

$$\begin{matrix}Math . 6 & \\ \frac{\partial L}{\partial p} = {\sum }_{i} [ {\sum }_{j ( > i )} {q}_{i , j} {x}_{j} + 2 {q}_{i , i} {x}_{i} ] \frac{\partial {x}_{i}}{\partial p} & ( Math . 6 )\end{matrix}$$

Since (Math. 6) becomes 0 when x=0 (xᵢ=0 for any i), the loss function of (Math. 4) has x=0 as a local solution. Therefore, when the loss function of (Math. 4) is used, there is a tendency for the GNN to easily become trapped in the local solution of x=0 when learning.

Therefore, it is preferable that the linear expression of the variable x is separated from the quadratic expression and handled as the linear expression as in (Math. 1). That is, the loss function L may be in the form of (Math. 7).

$$\begin{matrix}Math . 7 & \\ L = {\sum }_{i , j ( > i )} {q}_{i , j} {x}_{i} {x}_{j} + {\sum }_{i} {h}_{i} {x}_{i} ( = {x}^{T} Qx + {h}^{T} x ) & ( Math . 7 )\end{matrix}$$

Here, hᵢ in (Math. 7) is equal to the coefficient q_{i, i} in the case of i=j in (Math. 4). When the coefficients q_{i, j} and hᵢ in (Math. 7) are made to correspond to (Math. 1), (Math. 8) and (Math. 9) are obtained.

$$\begin{matrix}Math . 8 & \\ {q}_{i , j} = \{ \begin{matrix}P & ( i < j ∧ ( i , j ) ∈ E ) \\ 0 & ( otherwise )\end{matrix} & ( Math . 8 )\end{matrix}$$

$$\begin{matrix}Math . 9 & \\ \begin{matrix}{h}_{i} = - 1 & ∀ i\end{matrix} & ( Math . 9 )\end{matrix}$$

Here, an example of separating the loss function of the main GNN into a quadratic expression and a linear expression will be described with reference to FIG. 15. FIG. 15 illustrates the expression x^{T}Qx+h^{T}x of (Math. 7) in a matrix form, and all diagonal terms of the interaction matrix Q are 0. Therefore, when (Math. 7) is differentiated with respect to a certain learning parameter p, (Math. 10) is obtained.

$$\begin{matrix}Math . 10 & \\ \frac{\partial L}{\partial p} = {\sum }_{i} [ {\sum }_{j ( > i )} {q}_{i , j} {x}_{j} + {h}_{i} ] \frac{\partial {x}_{i}}{\partial p} & ( Math . 10 )\end{matrix}$$

Since (Math. 10) does not become 0 even when x=0 unlike (Math. 6), x=0 is not a local solution in the loss function of (Math. 7). Therefore, the learning using the loss function of (Math. 7) tends to proceed more smoothly than the learning using (Math. 4). Therefore, in the present embodiment, it is desirable to preferentially use (Math. 10). Here, “preferentially use” means that (Math. 10) may be used, or if the learning result obtained by using (Math. 10) is not a desired result, (Math. 4) may also be used. Both of (Math. 10) and (Math. 4) may be used.

Here, a comparison of learning processes of the main GNN using different loss functions will be described with reference to FIG. 16. FIG. 16 illustrates a solving process by the GNN of the maximum independent set problem for the instance frb40-19-1 of the BHOSLIB benchmark set. In FIG. 16, the vertical axis represents a loss function value, and the horizontal axis represents a learning time. The penalty coefficient P in the loss function was set to 2, and learning was performed using a two-layer GCN with two loss functions of the x^{T}Qx format of (Math. 4) and the x^{T}Qx+h^{T}x format of (Math. 7).

As a result, it was confirmed that in the x^{T}Qx format, the learning does not proceed any further as the loss function value remains at 0 due to being trapped in the local solution at x=0, whereas in the x^{T}Qx+h^{T}x format, the learning proceeds to a lower (better) loss function value than that in the x^{T}Qx format. Such a tendency can be confirmed not only in other instances of the BHOSLIB benchmark set but also in the DIMACS benchmark set.

In processing step S206, a feature vector (scalar in the maximum independent set problem) of each vertex of the final layer is obtained as an output of the learning of the main GNN. Although it is desirable to acquire the binary variable value of each vertex as the solution of the maximum independent set problem, values acquired through the activation function in the GNN are not necessarily binary variables, and are generally acquired as continuous values.

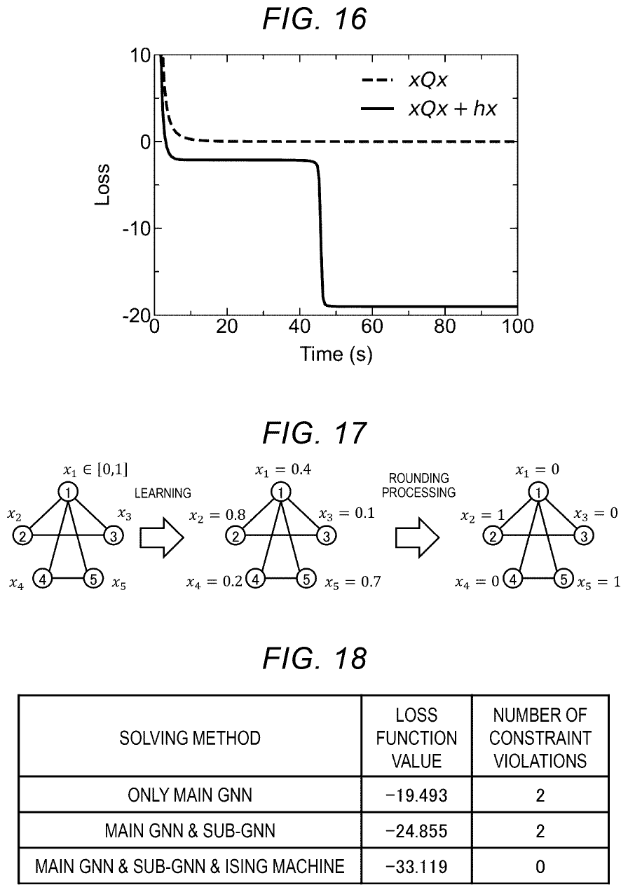

Next, a procedure of rounding an output of continuous values obtained as a result of the learning of the main graph to binary values will be described with reference to FIG. 17. FIG. 17 illustrates how the continuous values obtained by the learning of the GNN are converted into binary variables. For example, when a sigmoid function is used as the activation function, the output xᵢ of the GNN is a continuous value included in the section [0, 1] (see the “learning” process in the drawing). Therefore, it is necessary to convert these continuous values into binary variables on some criterion. In the example illustrated in FIG. 17, xᵢ is rounded to 1 when xᵢ is 0.5 or more and to 0 when xᵢ is less than 0.5 (see the “rounding processing” process in the drawing). As a result, the variables assigned to the vertexes 2 and 5 are converted into 1, and the variables assigned to the vertexes 1, 3, and 4 are converted into 0. Such rounding processing may not be based on a clear threshold value (0.5 in this case) but may instead reflect the continuous values obtained as a result of the learning of the GNN and probabilistically round to 0 or 1, for example.

Here, in processing step S207, the solution output unit 119 calculates the objective function value, the number of constraint violations, and the like serving as the optimization index using the solution x of the binary variable obtained in processing step S206, and outputs these calculation results together with the solution x. At this time, x which is a continuous value before the rounding processing is performed may also be output as the output of the GNN. In the case of the maximum independent set problem, for example, in addition to the objective function value of (Math. 1), the size of the independent set (first term of H in (Math. 1)) and the number of edges between vertexes where xᵢ=1 as the number of constraint violations (second term of H in (Math. 1)) are calculated. The result is presented to the user via the output device 105 or the communication device 106.

The contents of the optimization processing is described above along the flowchart illustrated in FIG. 3, and the performance of the optimization processing will be described finally. Here, the influence on the solving performance in the optimization processing will be described. FIG. 18 is a table for comparing the performance of various solving methods of the maximum independent set problem with respect to a graph artificially created with the number of vertexes of 100,000 and a degree of 5 for all vertexes. In FIG. 18, the loss function value is a value obtained by calculating H in (Math. 1) as a continuous value in the section [0, 1] output by the main GNN before the rounding processing in FIG. 17 is executed. However, the penalty coefficient P was set to 2. The number of constraint violations is the number of constraint violations (the number of edges in the independent set) calculated in processing step S207 in FIG. 3 after the variable of each vertex is rounded to 0 or 1 to determine the vertexes included in the independent set.

Here, in solving using only the main GNN in the present embodiment, the loss function is created directly from the main graph without creating the subgraph, the feature vector of the main GNN is randomly initialized, and the learning of the main GNN is executed. This corresponds to a case in which processing steps S202 to S206 are omitted in the optimization processing S200.

In the case of the main GNN & sub-GNN, the combinatorial optimization problem on each subgraph is solved by the sub-GNN alone. This can be achieved by setting the weighting coefficient a=0 in (Math. 11) in processing step S42432.

$$\begin{matrix}Math . 11 & \\ L ( x ) = a {‖ x - {x}_{sol} ‖}^{2} + bH ( x ) & ( Math . 11 )\end{matrix}$$

This optimization processing substantially corresponds to omitting processing step S203 and training the sub-GNN without labeled training data in processing step S204.

The case of the main GNN & sub-GNN & Ising machine corresponds to a case in which all processing steps in FIG. 3 are executed, and in the present embodiment, the Ising machine is used as the mathematical optimization solver. In each solving method, the GNN was constructed as a two-layer GCN, and as the activation function, a ReLU function was used for a first layer, and a sigmoid function was used for a second layer. In the case of the main GNN & sub-GNN and the case of the main GNN & sub-GNN & Ising machine, the Louvain method was used to create subgraphs.

When the results of the case of only the main GNN and the case of the main GNN & sub-GNN are compared, it can be confirmed that the finally obtained loss function value is improved by compressing a huge main graph into a subgraph and utilizing the result obtained by solving the subgraph. Further, when the results of the case of the main GNN & sub-GNN and the case of the main GNN & sub-GNN & Ising machine are compared, it can be confirmed that the loss function value is further improved by utilizing the solution of the Ising machine with respect to the subgraph. Further, only the case of the main GNN & sub-GNN & Ising machine can output an executable solution in which the number of constraint violations is 0, and the effect of executing all processing steps in FIG. 3 can be confirmed.

Next, the relation between the scale of the subgraph and the solution accuracy of the main GNN will be described. When compressing or dividing the main graph to create subgraphs, a plurality of subgraphs may be created as long as the subgraph can be scaled down so as to be handled by a mathematical optimization solver. However, since the feature and similarity of the main graph are almost lost in a subgraph that is extremely small in scale compared with the main graph, it is expected that the effect is small even when the information obtained from the learning of the sub-GNN is diverted to the main GNN.

Therefore, the present inventors created an artificial main graph with the number of vertexes of 150,000 and a degree of 5 for all vertexes, and investigated how the output of the main GNN changed depending on up to the learning result of which subgraph compressed by the Louvain method was used. The Ising machine used in the present embodiment can handle up to 100,000 variables at maximum. Therefore, a subgraph was created so that the scale was 100,000 vertexes or less.

Here, the relation between the number of subgraphs used for learning and the solution accuracy of the main GNN in the present embodiment will be described. The table in FIG. 19 illustrates the performance difference from the case of using up to the subgraph 1 to the case of using up to the subgraph 4. The number of vertexes indicates the number of vertexes of a graph having the smallest scale among graphs used as subgraphs. That is, the number of vertexes in the case of “up to subgraph 1” indicates the number of vertexes of the subgraph 1, and the number of vertexes in the case of “up to subgraph 2” indicates the number of vertexes of the subgraph 2. The arrival degree of the loss function value indicates the ratio of the loss function value of the main GNN relative to the case of using up to the subgraph 7.

As illustrated in FIG. 19, it can be confirmed that the arrival degree of the loss function value reaches 94.06% at the time point when the learning result of the subgraph 1 having the largest scale is used, and the improvement of the loss function value is slowed down even when the learning results of subgraphs smaller in scale are incorporated thereafter. This means that most of useful information acquired by the main GNN is transferred from the subgraph 1. That is, it is important to use the solution result in the subgraph having a size as close as possible to that of the main graph in improving the solution accuracy. Considering that the sub-GNN is assisted by the mathematical optimization solver in solving the subgraph, it can be said that it is important to create a subgraph as large as possible within a range that can be handled by the mathematical optimization solver in order to achieve higher solution accuracy. As described above, the solution being approximate in the present embodiment indicates closeness in terms of the scale of the graph.

Although the embodiment of the invention is described in detail above, the invention is not limited to the embodiment, and it is needless to say that various modifications can be made without departing from the gist of the invention. For example, the embodiment described above is described in detail to facilitate understanding of the invention, and the invention is not necessarily limited to those including all the configurations described above. In addition, another configuration can be added to, deleted from, or replaced with a part of a configuration of the embodiment.

In addition, a part or all of the configurations, functional units, processing units, processing methods, and the like described above may be implemented by hardware by, for example, designing with an integrated circuit. In addition, the configurations, functions, and the like described above may be implemented by software by a processor interpreting and executing a program for implementing each function. Information such as a program, a table, and a file for implementing each function can be stored in a recording device such as a memory, a hard disk, or a solid state drive (SSD), or in a recording medium such as an IC card, an SD card, or a DVD.

In addition, in each drawing described above, control lines and information lines that are considered necessary for description are shown, and not all the control lines and information lines on implementation are necessarily shown. For example, it may be considered that almost all configurations are actually interconnected.

Arrangements of the various functional units, various processing units, and various databases of the information processing apparatus 100 described above are merely examples. The arrangements of the various functional units, various processing units, and various databases may be changed to optimal arrangements from the viewpoint of performance, processing efficiency, communication efficiency, and the like of hardware and software provided in the information processing apparatus 100.

In addition, the configuration (schema, and the like) of the database storing the above-described various pieces of data may be flexibly changed from the viewpoint of efficient use of resources, improvement in processing efficiency, improvement in access efficiency, improvement in search efficiency, and the like.

What is claimed is:

1. An information processing apparatus for processing a combinatorial optimization problem that allows to be defined on a graph, the information processing apparatus comprising:
a problem data acquisition unit configured to receive problem data;
a graph creation unit configured to create one or more subgraphs by downscaling a main graph that is the graph to be solved, by referring to the problem data;
a mathematical optimization unit configured to solve a combinatorial optimization problem for each of the subgraphs by a mathematical optimization solver;
a machine learning unit configured to train a sub-GNN corresponding to each of the subgraphs such that an output of the sub-GNN is approximate to a solution of the mathematical optimization solver, using the solution obtained by the mathematical optimization solver as labeled training data;
a feature vector assignment unit configured to assign a feature vector at each vertex of the sub-GNN obtained as a result of the training to each corresponding vertex of a main GNN corresponding to graph data of the main graph as an input of a feature vector of the main GNN; and
a solution output unit configured to output a solution obtained as a result of the machine learning unit training the main GNN by setting a loss function to solve the combinatorial optimization problem for the main graph.

2. The information processing apparatus according to claim 1, further comprising:
a mathematical expression creation unit configured to, when a quadratic expression is included in an objective function of the combinatorial optimization problem, convert a term of the quadratic expression represented by a square of the same binary variable into a linear term while maintaining a coefficient of a quadratic term, and create a mathematical expression of the objective function by a quadratic expression including only a cross term that is a product between different variables and a linear expression including the converted linear term.

3. The information processing apparatus according to claim 1, wherein
the graph creation unit downscales the main graph to create the one or more subgraphs each having a smaller scale than the main graph.

4. The information processing apparatus according to claim 3, wherein
the graph creation unit
divides the main graph into clusters using a predetermined clustering method, and
creates the subgraphs by graph compression in which the clusters obtained by the division are regarded as a single vertex to create the subgraphs, and/or by graph division in which the clusters obtained by the division are regarded as separate subgraphs.

5. The information processing apparatus according to claim 4, wherein
the graph creation unit acquires a subgraph of a maximum scale by repeating subgraph creation processing while changing a setting parameter in the clustering method.

6. The information processing apparatus according to claim 1, wherein
the information processing apparatus determines a feature of the combinatorial optimization problem, and selects the mathematical optimization solver based on the determined feature, such that an Ising machine is selected if an objective function is determined to be a quadratic expression, a linear programming solver is selected if the objective function is determined to be a linear expression, a constraint programming solver is selected if only a constraint condition is present, and a problem specialized algorithm is selected if a problem specialized algorithm is present.

7. The information processing apparatus according to claim 1, further comprising
a loss function creation unit configured to create a mathematical expression as a loss function by weighting and summing both a square error with a solution of each of the subgraphs and an objective function of the combinatorial optimization problem defined on the subgraph.

8. The information processing apparatus according to claim 4, wherein
the graph creation unit determines from which vertex of the main graph each vertex of each of the subgraphs is created, and sets, as an initial input value of the feature vector of each vertex of the main GNN, a linear combination of the feature vector obtained by training the sub-GNN for a vertex group of the subgraph corresponding to each vertex of the main GNN.

9. An information processing method to be executed by an information processing apparatus for processing a combinatorial optimization problem that allows to be defined on a graph, the information processing method comprising:
receiving problem data, by a problem data acquisition unit;
creating one or more subgraphs by downscaling a main graph that is the graph to be solved, by referring to the problem data, by a graph creation unit;
solving a combinatorial optimization problem for each of the subgraphs by a mathematical optimization solver, by a mathematical optimization unit;
training a sub-GNN corresponding to each of the subgraphs such that an output of the sub-GNN is approximate to a solution of the mathematical optimization solver, using the solution obtained by the mathematical optimization solver as labeled training data, by a machine learning unit;
assigning a feature vector at each vertex of the sub-GNN obtained as a result of the training to each corresponding vertex of a main GNN corresponding to graph data of the main graph as an input of a feature vector of the main GNN, by a feature vector assignment unit; and
outputting a solution obtained as a result of the machine learning unit training the main GNN by setting a loss function to solve the combinatorial optimization problem for the main graph, by a solution output unit.

10. The information processing method according to claim 9, further comprising:
the graph creation unit downscaling the main graph to create the one or more subgraph each having a smaller scale than the main graph.
